(19) United States
(12) Patent Application Publication
(10) Pub. No.: US 2013/0082126 A1
(43) Pub. Date: Apr. 4, 2013

(54) PRESSURE BALANCED GASEOUS FUEL INJECTOR AND METHOD FOR MAKING THE SAME

(71) Applicant: MAHORO M. FUJITA, FAIRPORT, NY (US)

(72) Inventor: MAHORO M. FUJITA, FAIRPORT, NY (US)

(73) Assignee: DELPHI TECHNOLOGIES, INC., TROY, MI (US)

(21) Appl. No.: 13/251,669

(22) Filed: Oct. 3, 2011

(51) Int. Cl. F02M 51/00

(52) U.S. Cl. 239/585.1

(57) ABSTRACT

A fuel injector is provided for supplying fuel to a fuel consuming device. The fuel injector includes a fuel injector fuel inlet for receiving fuel, a fuel injector fuel outlet for dispensing fuel from the fuel injector, an upper valve seat, and a lower valve seat. An armature selectively seats and unseats with the upper valve seat and the lower valve seat. A balancing chamber is in constant fluid communication with the fuel injector fuel inlet and disposed between the upper valve seat and the lower valve seat. Fuel within the balancing chamber acts on the armature to urge the armature away from the upper valve seat and fuel within the balancing chamber acts on the armature to urge the armature toward the lower valve seat, thereby reducing the force to unseat the armature from the upper valve seat and the lower valve seat.

### TECHNICAL FIELD OF INVENTION

The present invention relates to fuel injectors for supplying fuel to a fuel consuming device; and more particularly to fuel injectors for supplying a gaseous fuel to an internal combustion engine; and most particularly to such a gaseous fuel injector which has a pressure balanced valve mechanism.

### BACKGROUND OF INVENTION

One type of fuel that is used to power internal combustion engines and other fuel consuming devices is a gaseous fuel such as natural gas in the form of compressed natural gas (CNG), liquefied petroleum gas (LPG) or Hydrogen (H₂). Fuel injectors for supplying a metered amount of gaseous fuel to a fuel consuming device such as an internal combustion engine are well known. In a typical fuel injector, a valve member is located in a fuel passage of the fuel injector and is axially reciprocated to seat and unseat the valve member with a valve seat to control the flow of fuel through the fuel injector. However, some fuel consuming devices, for example internal combustion engines employing injection of fuel directly into the combustion chamber, require fuel high pressures to operate. The fuel pressure in this application may be 20 bar or even greater. Fuel pressure of a large magnitude applied to the valve member results in a large hydraulic force on the valve member. Consequently, a large force is required to unseat the valve member from the valve seat. The hydraulic force may be so large that it is cost and space prohibitive to provide an actuator for reciprocating the valve member against this pressure.

Pressure balanced fuel injectors have been developed to reduce the force required by the actuator. A pressure balanced fuel injector may include first and second valve members which are axially reciprocated simultaneously to seat and unseat the first and second valve member with first and send valve seats respectively to control the flow of fuel through the fuel injector. When the first and second valve members are seated with first and second valve seats respectively, fuel pressure acts on the first valve member to urge the first valve member toward the first valve seat while fuel pressure acts on the second valve member to urge the second valve member away from the second valve seat. In this way, the fuel pressure acting on the first and second valve members counteract each other, thereby reducing the force needed to unseat the first and second valve members from the first and second valve seats respectively.

One pressure balanced fuel injector is shown in International Patent Application Publication WO 98/26168. In this fuel injector, a solenoid includes a coil, a stationary solenoid pole, and an axially moveable valve stem which acts as the armature. The valve stem extends axially into a housing with a stepped bore, a fuel inlet and a fuel outlet. A separation ring defining a first valve seat is inserted into a first end of the stepped bore and rests on a first shoulder defined by the stepped bore. A sleeve defining a second valve seat is inserted into a second end of the stepped bore and rests on a second shoulder defined by the stepped bore. A first seal ring defining a first valve member is carried in a first groove formed in the exterior surface of the valve stem while a second seal ring defining a second valve member is carried in a second groove formed in the exterior surface of the valve stem. When the coil of the solenoid is not energized, a spring urges the valve stem to seat the first and second valve members with the first and second valve seats respectively. When the first and second valve members are seated with the first and second valve seats respectively, pressurized fuel acts on the first and second valve members in opposing directions, thereby reducing the force needed to unseat the first and second valve members from the first and second valve seats respectively.

While the arrangement of first and second valve members and first and second valve seats shown in WO 98/26168 may reduce the force needed to unseat the first and second valve members from the first and second valve seats respectively, the components must be made with a high degree of precision in order to ensure that the first and second valve members seat simultaneously with the first and second valve seats respectively. This is due to the fact that the axial locations of the first and second valve seats are dependent on at least the location of the shoulders defined by the stepped bore, the thickness of the separation ring, and the location of the second valve seat on the sleeve. This is also due to the fact that the axial locations of the first and second valve members are dependent on at least the locations of the first and second grooves in the valve stem. Manufacturing variations in any of these features may result in unsatisfactory control of fuel through the fuel injector.

What is needed is a pressure balanced fuel injector with first and second valve member and first and second valve seats which is tolerant to manufacturing variations of individual components while allowing for simultaneous seating of the first valve member with the first valve seat and the second valve member with the second valve seat.

### SUMMARY OF THE INVENTION

Briefly described, the present invention provides a fuel injector for supplying fuel to a fuel consuming device. The fuel injector includes a fuel injector fuel inlet for receiving fuel, a fuel injector fuel outlet for dispensing fuel from the fuel injector, an upper valve seat, and a lower valve seat. The fuel injector also includes an armature which is axially moveable to selectively seat and unseat with the upper valve seat and the lower valve seat. Fuel is prevented from flowing across the upper valve seat and the lower valve seat from the fuel injector fuel inlet to the fuel injector fuel outlet when the armature is seated with the upper valve seat and the lower valve seat. Fuel is permitted to flow across the upper valve seat and the lower valve seat from the fuel injector fuel inlet to the fuel injector fuel outlet with the armature is unseated with the upper valve seat and the lower valve seat. The fuel injector also includes a balancing chamber in constant fluid communication with the fuel injector fuel inlet and disposed between the upper valve seat and the lower valve seat such that fuel within the balancing chamber acts on the armature to try to urge the armature away from the upper valve seat and to try to urge the armature toward the lower valve seat, thereby reducing the force required to unseat the armature from the upper valve seat and the lower valve seat.

### BRIEF DESCRIPTION OF DRAWINGS

This invention will be further described with reference to the accompanying drawings in which:

FIG. 1 is an exploded isometric view of a fuel injector in accordance with the present invention;

FIG. 2 is an axial cross section of a fuel injector in accordance with the present invention;

FIG. 3 is the axial cross section of FIG. 2 showing an upper armature seated with a first valve seat, a lower armature seated with a second valve seat, and the fuel pressure acting is opposing directions on the upper armature and the lower armature; and

FIG. 4 is the axial cross section of the fuel injector of FIG. 3 now showing the upper armature unseated with the first valve seat, the lower armature unseated with second valve seat, and the fuel flow paths through the fuel injector.

### DETAILED DESCRIPTION OF INVENTION

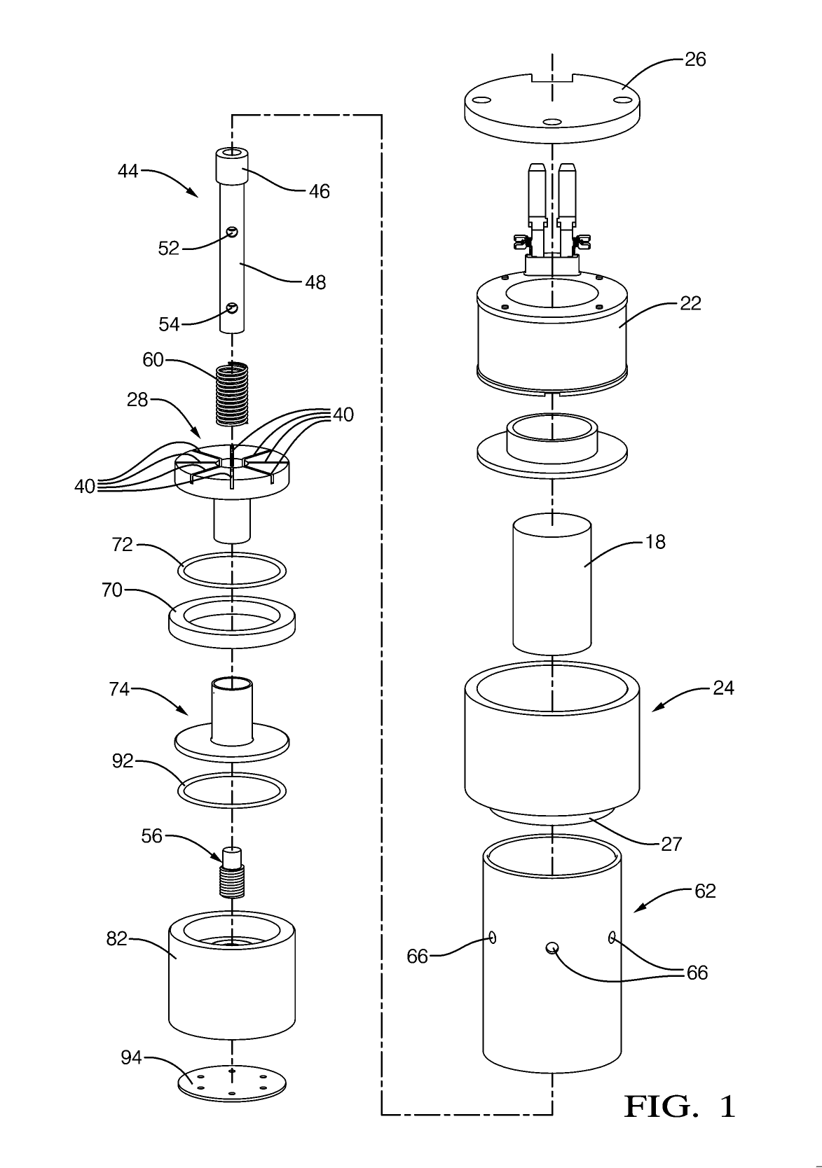

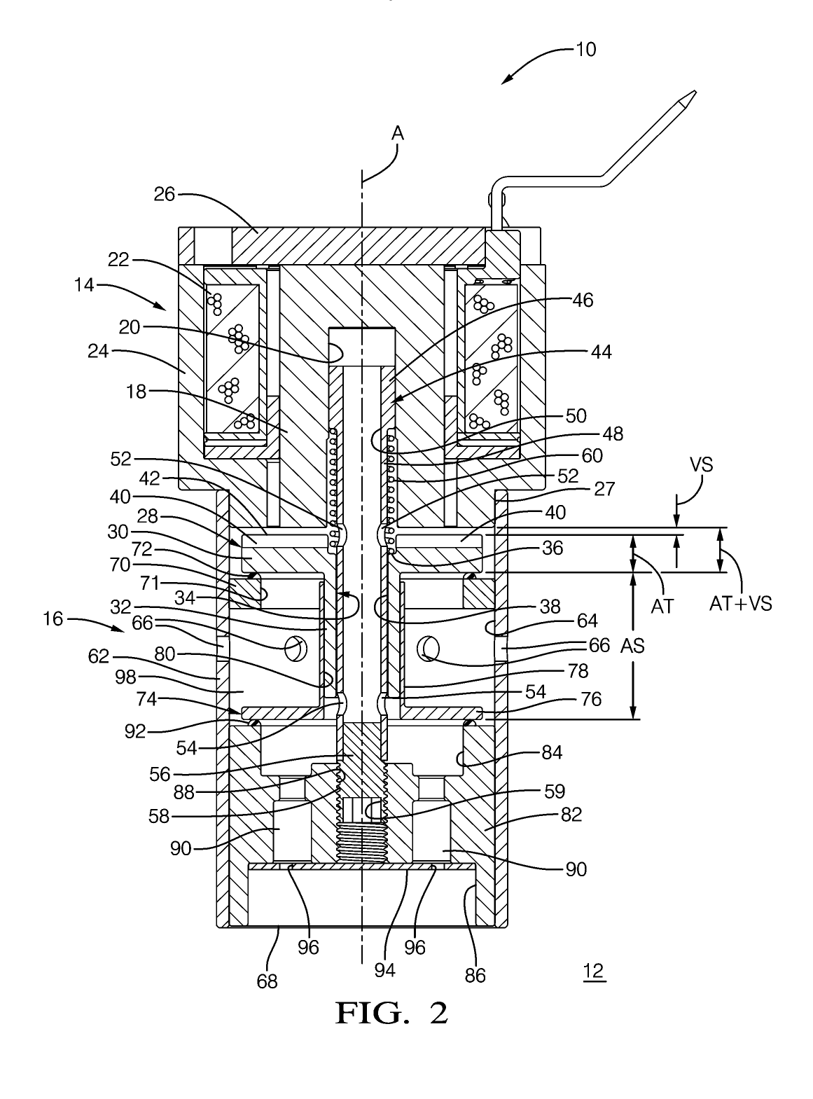

In accordance with a preferred embodiment of this invention and referring to FIGS. 1 and 2, fuel injector 10 extending along central axis A is shown for selectively supplying fuel to fuel consuming device 12. Fuel injector 10 includes solenoid actuator 14 and fuel control section 16. Solenoid actuator 14 working together with fuel control section 16 controls the supply of fuel the fuel consuming device 12.

Solenoid actuator 14 includes a pole member 18 which is stationary and which is made of a magnetic material. Pole member 18 includes pole member central bore 20 extending axially part way thereinto. The open end of pole member central bore 20 faces toward fuel control section 16.

Solenoid actuator 14 also includes coil 22 which radially surrounds a portion of poll member 18 and which is selectively energized by an electric current.

Solenoid actuator 14 also includes solenoid housing 24 made of a magnetic material which receives pole member 18 and coil 22 therewithin. Solenoid housing 24 is closed by solenoid housing cover 26 at one end which is opposite fuel control section 16. Solenoid housing cover 26 is made of a magnetic material. Solenoid housing 24 is open at the other end which is adjacent fuel control section 16 and includes solenoid housing attachment section 27 which extends axially into fuel control section 16 to attach solenoid actuator 14 to fuel control section 16, and to set the valve stroke VS of fuel injector 10.

Upper armature 28 is disposed axially adjacent pole member 18 and is made of a magnetic material. Upper armature 28 includes upper armature disk-shaped section 30 and upper armature tubular section 32. Upper armature disk-shaped section 30 has an armature thickness AT in the axial direction. Upper armature tubular section 32 is smaller in diameter than said upper armature disk-shaped section 30 and extends coaxially away from upper armature disk-shaped section 30 in the direction opposite from pole member 18. Upper armature 28 also includes upper armature stepped bore 34 which extends coaxially through both upper armature disk-shaped section 30 and upper armature tubular section 32. Upper armature stepped bore 34 includes upper armature spring pocket section 36 which extends axially part way into upper armature 28 from upper armature disk-shaped section 30. Upper armature stepped bore 34 also includes upper armature guiding section 38 which extends axially from upper armature spring pocket section 36 the remainder of the way through upper armature 28. Upper armature guiding section 38 is sized to be smaller in diameter than upper armature spring pocket section 36. Upper armature 28 also includes a plurality of upper armature fuel passage grooves 40 in upper armature end face 42 of upper armature disk shaped section 30 which faces axially toward pole member 18. Upper armature fuel passage grooves 40 extend radially outward from upper armature stepped bore 34 to the outer circumference of upper armature disk shaped section 30. In addition to providing a fuel flow path as will be described later, upper armature fuel passage grooves 40 may also help to reduce eddy currents in the magnetic circuit during times when coil 22 is energized or dis-energized. Upper armature disk-shaped section 30 serves as a first valve member as will be described in more detail later.

Armature guide 44 is provided to substantially prevent radial movement of upper armature 28 and to axially guide upper armature 28. Armature guide 44 includes armature guide larger diameter section 46 which is disposed within pole member central bore 20 and which is sized to be a clearance fit with pole member central bore 20 to substantially prevent radial movement of armature guide larger diameter section 46 while permitting armature guide larger diameter section 46 to freely slide into pole member central bore 20 during assembly. Armature guide 44 also includes armature guide smaller diameter section 48 extending axially away from armature guide larger diameter section 46, outward from pole member central bore 20, and through upper armature 28. Armature guide smaller diameter section 48 is sized to form an annular space with pole member central bore 20 and to form a clearance fit with upper armature guiding section 38 of upper armature 28 to substantially prevent radial movement of upper armature 28 while permitting upper armature 28 to freely move axially during use. Armature guide 44 also include armature guide bore 50 extending axially therethrough. Armature guide fuel inlet passages 52 extend radially through armature guide smaller diameter section 48 to provide fluid communication from the outer surface of armature guide 44 to armature guide bore 50 while armature guide fuel outlet passages 54 extend radially outward through armature guide smaller diameter section 48 to provide fluid communication from armature guide bore 50 to the outer surface of armature guide 44. Armature guide fuel inlet passages 52 are axially aligned with upper armature spring pocket section 36 while armature guide fuel outlet passages 54 are disposed axially beyond the end of upper armature 28 that is distal from pole member 18.

The end of armature guide bore 50 distal from armature guide larger diameter section 46 is blocked with adjusting screw 56 which is fixed to armature guide 44, for example, by press fit or welding. Adjusting screw 56 extends axially away from armature guide 44 and includes adjusting threads 58 on the outer circumference thereof. Adjusting screw 56 also includes drive feature 59 extending axially into the axial end of adjusting screw 56 distal from armature guide 44. Drive feature 59 may be, for example, an internal hex, screwdriver slot, internal Torx® drive, or any other shape known to receive a rotary tool for imparting rotational motion. The function provided by adjusting screw 56 will be described in more detail below.

Return spring 60 radially surrounds a portion of armature guide 44 and is disposed axially between armature guide larger diameter section 46 of armature guide 44 and upper armature spring pocket section 36 of upper armature 28. Return spring 60 provides a force to bias upper armature 28 away from pole member 18.

Fuel control section 16 includes fuel control housing 62 which is attached at one end to solenoid housing 24, for example, by press fit, welding, or crimping. Fuel control housing 62 includes fuel control housing central bore 64 extending axially therethrough. Fuel control housing control bore 64 may have a constant diameter. Fuel control housing 62 also includes fuel injector fuel inlets 66 for receiving pressurized fuel from a fuel source (not shown). Fuel injector fuel inlets 66 extend radially through fuel control housing 62 to communicate fuel to fuel control housing central bore 64 from the fuel source. Fuel control housing 62 also includes fuel injector fuel outlet 68 for dispensing fuel from fuel injector 10. Fuel injector fuel outlet 68 is the axial end of fuel control housing 62 distal from solenoid actuator 14.

Fuel control section 16 also includes upper valve seat 70 which is disposed within fuel control housing central bore 64. Upper valve seat 70 is disposed axially between upper armature disk-shaped section 30 and fuel injector fuel outlet 68. Upper valve seat 70 is annular in shape and sized to fit closely with fuel control housing central bore 64 to prevent fuel from passing between the outer circumference of upper valve seat 70 and fuel control housing central bore 64. Upper valve seat 70 is fixed to fuel control housing 62, for example, by welding. The annular shape of upper valve seat 70 defines upper valve seat central passage 71 which is smaller in diameter than upper armature disk-shaped section 30 and which allows upper armature tubular section 32 to pass therethrough. Upper valve seat 70 includes upper valve seat seating surface 72 on the axial face of upper valve seat 70 that faces toward upper armature disk-shaped section 30. Upper valve seat seating surface 72 may be a compliant material, for example fluorocarbon, which is fixed thereto, for example, by direct molding. The compliant nature of upper seating surface valve seat provides positive sealing with upper armature 28.

Fuel control section 16 also includes lower armature 74 which is of separate construction from upper armature 28. Lower armature 74 includes lower armature disk-shaped section 76, lower armature tubular section 78, and lower armature central bore 80 extending axially therethrough. Lower armature disk-shaped section 76 is spaced axially from upper armature disk-shaped section 30 such that fuel injector fuel inlets 66 are axially between lower armature disk-shaped section 76 and upper armature disk-shaped section 30. Lower armature tubular section 78 is smaller in diameter than said lower armature disk-shaped section 76 and radially surrounds upper armature tubular section 32 and extends coaxially away from lower armature disk-shaped section 76 toward upper armature disk-shaped section 30. Lower armature central bore 80 fits closely with upper armature tubular section 32 to prevent fuel from passing between lower armature central bore 80 and the outer circumference of upper armature tubular section 32. Lower armature 74 is fixed to upper armature 28, for example, by welding lower armature tubular section 78 to upper armature tubular section 32. Lower armature disk-shaped section 76 serves as a second valve member as will be described in more detail later. Upper armature 28 together with lower armature 74 form a spool-shaped armature that moves as a single unit.

Fuel control section 16 also includes lower valve seat 82 which is disposed within fuel control housing central bore 64. Lower valve seat 82 is disposed axially between lower armature disk-shaped section 76 and fuel injector fuel outlet 68. Lower valve seat 82 is sized to fit closely with fuel control housing central bore 64 to prevent fuel from passing between the outer circumference of lower valve seat 82 and fuel control housing central bore 64. Lower valve seat 82 is fixed to fuel control housing 62, for example, by welding. Lower valve seat 82 includes lower valve seat inlet bore 84 which extends part way into lower valve seat 82 from the axial end of lower valve seat 82 which faces toward lower armature disk-shaped section 76. Lower valve seat inlet bore 84 is sized to be smaller in diameter than lower armature disk-shaped section 76. Lower valve seat 82 also includes lower valve seat outlet bore 86 which extends axially part way into lower valve seat 82 from the axial end of lower valve seat 82 and which faces toward fuel injector fuel outlet 68. Lower valve seat 82 also includes lower valve seat adjusting bore 88 which extends coaxially through lower valve seat 82 and which is threaded for threadably receiving adjusting threads 58 of adjusting screw 56 therein. Lower valve seat 82 also includes lower valve seat flow passages 90 which are arranged in an array radially surrounding lower valve seat adjusting bore 88. Lower valve seat flow passages 90 extend axially through lower valve seat 82 and provide fluid communication from lower valve seat inlet bore 84 to lower valve seat outlet bore 86. Lower valve seat 82 includes lower valve seat seating surface 92 on the axial face of lower valve seat 82 that faces toward lower armature disk-shaped section 76. Lower valve seat seating surface 92 may be a compliant material, for example fluorocarbon, which is fixed thereto, for example, by direct molding. The compliant nature of lower valve seat seating surface 92 provides positive sealing with lower armature 74. Lower valve seat 82 may also include metering plate 94 disposed within lower valve seat outlet bore 86. Lower valve seat 82 includes metering orifices 96 extending axially therethrough. Each metering orifice 96 is aligned with one lower valve seat flow passage 90. Metering plate 94 may be fixed to the end of lower valve seat outlet bore 86 proximal to lower valve seat flow passages 90, for example, by welding. Metering plate 94 controls the maximum flow through fuel injector 10.

In order to assemble fuel injector 10, upper armature tubular section 32 of upper armature 28 is positioned within lower armature central bore 80 of lower armature 74 while upper valve seat 70 is held axially between upper armature disk-shaped section 30 of upper armature 28 and lower armature disk-shaped section 76 of lower armature 74 such that upper armature tubular section 32 passes through upper valve seat central passage 71. Upper armature tubular section 32 is positioned within lower armature central bore 80 to establish a predetermined armature spacing AS from the axial face of upper armature disk-shaped section 30 proximal upper armature tubular section 32 to the axial face of lower armature disk-shaped section 76 distal from lower armature tubular section 78. Upper armature 28 is then secured to lower armature 74, for example, by welding upper armature tubular section 32 to lower armature tubular section 78.

After upper armature 28 is secured to lower armature 74; upper armature 28, lower armature 74, and upper valve seat 70 are disposed within fuel control housing central bore 64 of fuel control housing 62. Upper valve seat 70 is then fixed to fuel control housing 62, for example, by welding. After fixing upper valve seat 70 to fuel control housing 62, upper armature 28 is held in axial contact with upper valve seat seating surface 72. Lower valve seat 82 is then inserted into fuel control housing central bore 64 of fuel control housing 62 until lower valve seat seating surface 92 axially contacts lower armature 74. Lower valve seat 82 is then fixed to fuel control housing 62, for example, by welding. In this way, simultaneous seating and unseating of upper armature 28 with upper valve seat 70 and lower armature 74 with lower valve seat 82 is assured.

After fixing lower valve seat 82 to fuel control housing 62, return spring 60 is disposed over armature guide smaller diameter section 48 to radially surround smaller diameter section 48 and adjusting screw 56 is fixed to armature guide 44. Armature guide smaller diameter section 48 with adjusting screw 56 is then inserted through upper armature stepped bore 34 and adjusting screw 56 is threaded into lower valve seat adjusting bore 88. It should be understood that return spring 60 may be disposed over armature guide smaller diameter section 48 and adjusting screw 56 may be fixed to armature guide 44 any time prior to inserting armature guide smaller diameter section 48 with adjusting screw 56 through upper armature stepped bore 34.

After adjusting screw 56 is threaded into lower valve seat adjusting bore 88, solenoid actuator 14 is attached to fuel control housing 62 by inserting solenoid housing attachment section 27 into fuel control housing central bore 64 to establish a predetermined distance from upper valve seat seating surface 72 to the axial end of solenoid housing attachment section 27 which is equal to armature thickness AT plus valve stroke VS. At the same time solenoid housing attachment section 27 is inserted into fuel control housing central bore 64, armature guide larger diameter section 46 is inserted into pole member central bore 20 of pole member 18. Next, solenoid actuator 14 is fixed to fuel control section 16, for example, by welding fuel control housing 62 to solenoid housing 24.

After solenoid actuator 14 is fixed to fuel control section 16, the force on return spring 60 is adjusted by rotating armature guide 44/adjusting screw 56 by engaging drive feature 59 with a rotary tool (not shown). Rotation of the rotary tool results in axial movement of armature guide 44. Consequently, the length of return spring 60 changes, resulting in a change in the spring force of return spring 60. The rotary tool is rotated until a desired force of return spring 60 is achieved, for example, by monitoring flow through fuel injector 10 by seating and unseating upper armature 28 with upper valve seat 70 and lower armature 74 with lower valve seat 82. After setting the force on return spring 60, adjusting screw 56 may be fixed in position to prevent movement thereof, for example, by spot welding or staking. Although armature guide 44 moves axially during assembly of fuel injector 10 as a result of rotating adjusting screw 56, armature guide 44 remains axially stationary during use of fuel injector 10. Lastly, metering plate 94 is inserted into lower valve seat outlet bore 86 and fixed thereto, for example, by welding.

This method of assembling fuel injector 10 accommodates for variations in individual components for example, thicknesses of upper armature disk-shaped section 30, lower armature disk-shaped section 76, upper valve seat 70, and lower valve seat 82 while ensuring simultaneous seating of upper armature 28 and lower armature 74 with upper valve seat 70 and lower valve seat 82. This method of assembling fuel injector 10 also ensures valve stroke VS is the desired magnitude. This method of assembling fuel injector 10 also allows for adjustment of the spring force of return spring 60 which may affect the time it takes fuel injector 10 to move from a closed position which prevents fuel from passing from fuel injector fuel inlets 66 to fuel injector fuel out 68 to an open position which allows fuel to pass from fuel injector fuel inlets 66 to fuel injector fuel outlet 68 and also the time it takes fuel injector 10 to move from the open position to the closed position. Providing a spring force of a desired magnitude is desirable for providing desired flow characteristics.

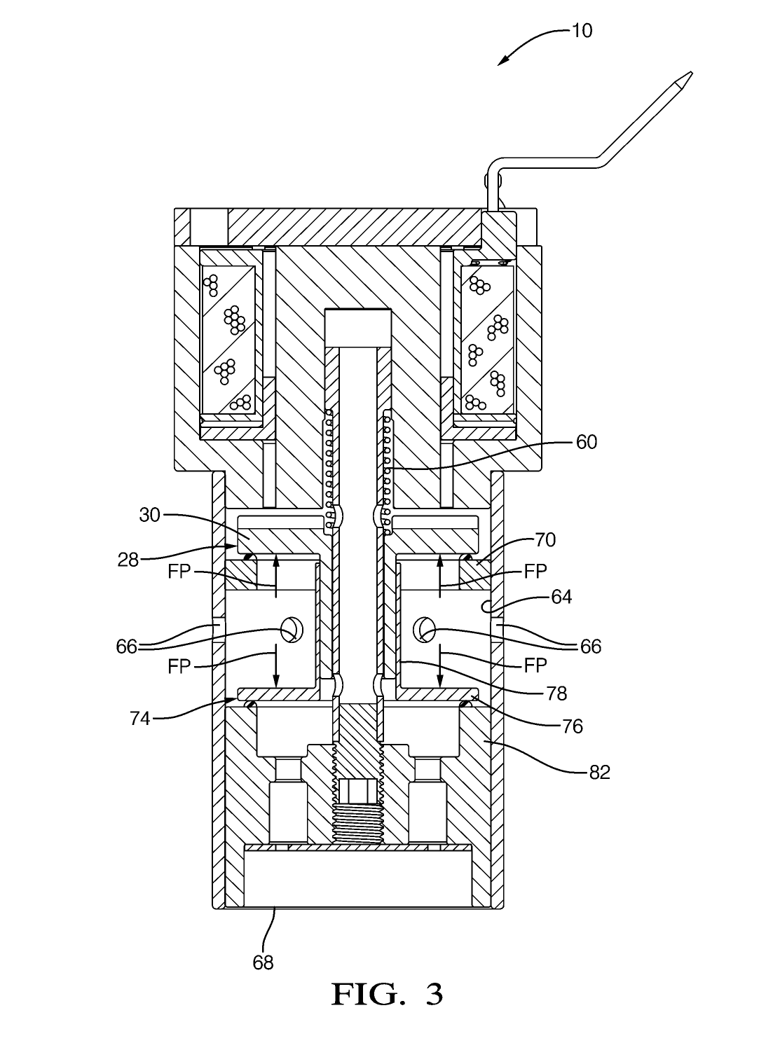

In operation and now referring to FIG. 3, fuel injector 10 is shown in a closed position which prevents fuel from passing from fuel injector fuel inlets 66 to fuel injector fuel out 68. In the closed position, upper armature 28 is seated with upper valve seat 70 and lower armature 74 is seated with lower valve seat 82. Pressurized fuel is supplied to balancing chamber 98 through fuel injector fuel inlets 66. Balancing chamber 98 is the annular space defined radially between lower armature tubular section 78 and fuel control housing central bore 64 and axially between upper armature disk-shaped section 30 and lower armature disk-shaped section 76. Fuel pressure FP acts on upper armature 28 to try to urge upper armature 28 to unseat with upper valve seat 70. Similarly, fuel pressure FP acts on lower armature 74. However, because fuel pressure FP acts on lower armature 74 in a direction opposite to that of fuel pressure FP acting on upper armature 28, fuel pressure FP acts to try to keep lower armature 74 seated with lower valve seat 82. The surface area in which fuel pressure FP acts axially on upper armature 28 and lower armature 74 may be substantially the same. Consequently the net force of fuel pressure FP on upper armature 28 and lower armature 74 is near zero. However, the spring force of return spring 60 keeps upper armature 28 seated with upper valve seat 70 and lower armature 74 seated with lower valve seat 82.

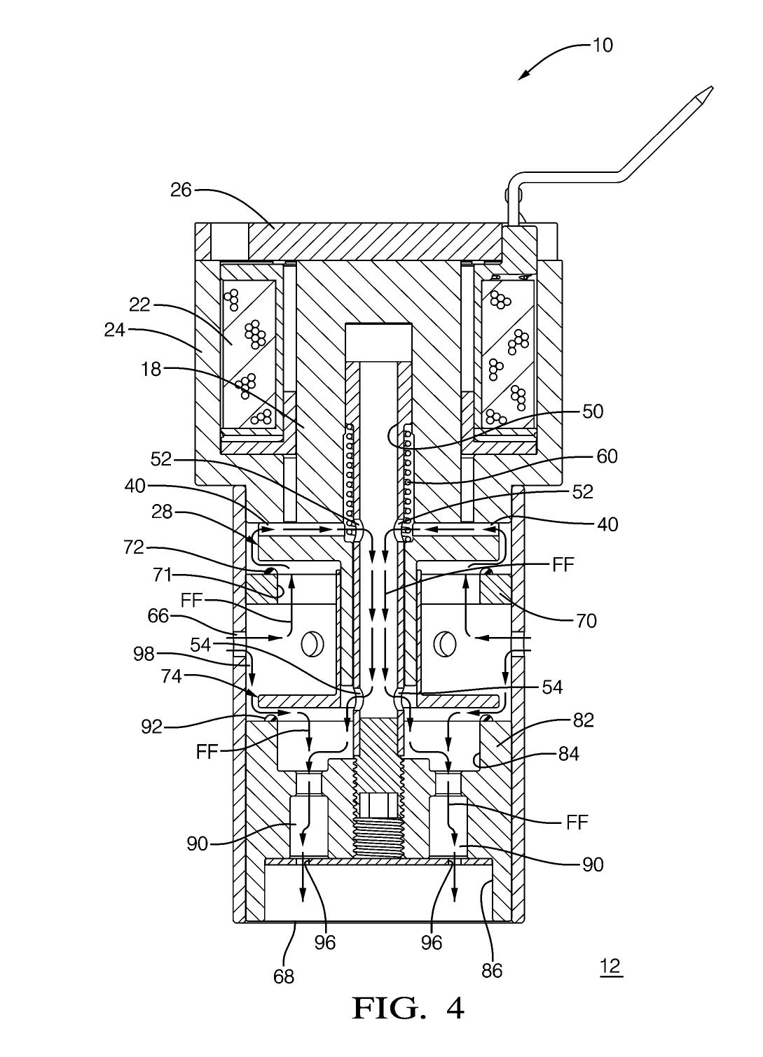

In operation and now referring to FIG. 4, fuel injector 10 is shown in an open position which allows fuel to pass from fuel injector fuel inlets 66 to fuel injector fuel outlet 68. This is accomplished by energizing coil 22 with an electric current which generates a magnetic field through the magnetic circuit comprising pole member 18, solenoid housing 24, solenoid housing cover 26, and upper armature 28 resulting in an attractive force between upper armature 28 and pole member 18. Consequently, upper armature 28 is moved axially toward pole member 18 a distance of valve stroke VS (shown in FIG. 2), thereby compressing return spring 60. Solenoids and their operation are well known to those skilled in the art and will not be further discussed herein. When upper armature 28 is moved axially toward pole member 18, upper armature 28 is unseated with upper valve seat 70 and lower armature 74 is unseated with lower valve seat 82. Consequently, two flow paths are created from fuel injector fuel inlets 66 to fuel injector fuel outlet 68.

One flow path is created by passing fuel from balancing chamber 98 between upper armature 28 and upper valve seat seating surface 72. After passing between upper armature 28 and upper valve seat seating surface 72, the fuel is passed axially across the outer circumference of upper armature disk-shaped section 30 where the fuel then passes through upper armature fuel passage grooves 40. After passing through upper armature fuel passage grooves 40, the fuel then passes between the coils of return spring 60 and enters armature guide bore 50 through armature guide fuel inlet passages 52. The fuel then passes axially through armature guide bore 50 and exits therefrom through armature guide fuel outlet passages 54. After exiting armature guide bore 50 and through armature guide fuel outlet passages 54, the fuel passes through lower valve seat 82 by passing through lower valve seat inlet bore 84, lower valve seat flow passages 90, metering orifices 96, and lower valve seat outlet bore 86. Finally, the fuel exits fuel injector 10 through fuel injector fuel outlet 68 where it is supplied to fuel consuming device 12.

Another flow path is created by passing fuel from balancing chamber 98 between lower armature 74 and lower valve seat seating surface 92. After passing between lower armature 74 and lower valve seat seating surface 92, the fuel passes through lower valve seat 82 by passing through lower valve seat inlet bore 84, lower valve seat flow passages 90, metering orifices 96, and lower valve seat outlet bore 86. Finally, the fuel exits fuel injector 10 through fuel injector fuel outlet 68 where it is supplied to fuel consuming device 12.

Arrows FF in FIG. 4 are included to show the fuel flow through fuel injector 10.

While the surface area in which fuel pressure FP acts axially on upper armature 28 and lower armature 74 has been described as being substantially the same, it should now be recognized that the surface area in which fuel pressure FP acts axially on upper armature 28 may be different from the surface area in which fuel pressure FP acts axially on lower armature 74 while still decreasing the force required by solenoid actuator 14 to unseat upper armature 28 and lower armature 74 from upper valve seat 70 and lower valve seat 82 respectively when compared to a non-pressure balanced fuel injector.

While lower armature 74 is fixed to upper armature 28, lower armature 74 may not be part of the magnetic circuit which causes attraction of upper armature 28 to pole member 18 when coil 22 is energized. Consequently, lower armature 74 may be a non-magnetic material.

While this invention has been described in terms of the preferred embodiments thereof, it is not intended to be so limited, but rather only to the extent set forth in the claims that follow.

We claim:

1. A fuel injector for supplying fuel to a fuel consuming device, said fuel injector comprising:
a fuel injector fuel inlet for receiving fuel;
a fuel injector fuel outlet for dispensing fuel from said fuel injector;
an upper valve seat;
a lower valve seat;
an armature which is axially moveable to selectively seat and unseat with said upper valve seat and said lower valve seat, wherein fuel is prevented from flowing across said upper valve seat and said lower valve seat from said fuel injector fuel inlet to said fuel injector fuel outlet when said armature is seated with said upper valve seat and said lower valve seat, and wherein fuel is permitted to flow across said upper valve seat and said lower valve seat from said fuel injector fuel inlet to said fuel injector fuel outlet when said armature is unseated with said upper valve seat and said lower valve seat; and
a balancing chamber in constant fluid communication with said fuel injector fuel inlet and disposed axially between said upper valve seat and said lower valve seat such that fuel within said balancing chamber acts on said armature to try to urge said armature away from said upper valve seat and such that fuel within said balancing chamber acts on said armature to try to urge said armature toward said lower valve seat, thereby reducing the force required to unseat said armature from said upper valve seat and said armature from said lower valve seat.

2. A fuel injector as in claim 1 wherein said armature includes an upper armature for selectively seating and unseating with said upper valve seat and a lower armature for selectively seating and unseating with said lower valve seat.

3. A fuel injector as in claim 2 further comprising an armature guide extending axially through said armature in a clearance fit, wherein said armature guide remains axially stationary when said armature is moved axially to seat and unseat with said upper valve seat and said lower valve seat.

4. A fuel injector as in claim 3 wherein said armature guide comprises:
an armature guide central bore;
an armature guide fuel inlet passage extending radially through said armature guide to provide fluid communication from said fuel injector fuel inlet to said armature guide central bore only when said armature is unseated with said upper valve seat; and
an armature guide fuel outlet passage in fluid communication with said armature guide fuel inlet passage and extending radially through said armature guide to provide fluid communication from said armature guide central bore to said fuel injector fuel outlet.

5. A fuel injector as in claim 3 wherein said upper armature comprises:
an upper armature disk-shaped section; and
an upper armature tubular section extending axially away from said upper armature disk-shaped section toward said lower armature.

6. A fuel injector as in claim 5 wherein said lower armature comprises:
a lower armature disk-shaped section; and
a lower armature tubular section extending axially away from said lower armature disk-shaped section toward said upper armature.

7. A fuel injector as in claim 6 wherein one of said upper armature tubular section and said lower armature tubular section radially surrounds the other of said upper armature tubular section and said lower armature tubular section, and wherein the other of said upper armature tubular section and said lower armature tubular section is a clearance fit with said armature guide.

8. A fuel injector as in claim 7 wherein said lower armature tubular section radially surrounds said upper armature tubular section and said upper armature tubular section is a clearance fit with said armature guide.

9. A fuel injector as in claim 2 wherein said upper armature is of separate construction from said lower armature.

10. A fuel injector as in claim 3 wherein said armature guide includes an adjusting screw with adjusting threads for threadably engaging a lower valve seat adjusting bore of said lower valve seat.

11. A fuel injector for supplying fuel to a fuel consuming device, said fuel injector comprising:
a fuel injector fuel inlet for receiving fuel;
a fuel injector fuel outlet for dispensing fuel from said fuel injector;
an upper valve seat;
a lower valve seat;
a solenoid actuator having a coil, a pole member stationary with said coil and coaxially within said coil, and an upper armature axially moveable and disposed axially from said pole member, wherein said upper armature selectively seats and unseats with said upper valve seat, wherein fuel is prevented from flowing across said upper valve seat from said fuel injector fuel inlet to said fuel injector fuel outlet when said upper armature is seated with said upper valve seat and wherein fuel is permitted to flow across said upper valve seat from said fuel injector fuel inlet to said fuel injector fuel outlet when said upper armature is unseated with said upper valve seat;
a lower armature for selectively seating and unseating with said lower valve seat, wherein fuel is prevented from flowing across said lower valve seat from said fuel injector fuel inlet to said fuel injector fuel outlet when said lower armature is seated with said lower valve seat and wherein fuel is permitted to flow across said lower valve seat from said fuel injector fuel inlet to said fuel injector fuel outlet when said lower armature is unseated with said lower valve seat; and
a balancing chamber in constant fluid communication with said fuel injector fuel inlet and disposed axially between said upper valve seat and said lower valve seat such that fuel within said balancing chamber acts on said upper armature to try to urge said upper armature away from said upper valve seat and such that fuel within said balancing chamber acts on said lower armature to try to urge said lower armature toward said lower valve seat, thereby reducing the force required to unseat said upper armature from said upper valve seat and said lower armature from said lower valve seat.

12. A fuel injector as in claim 11 further comprising an armature guide disposed in a pole member central bore of said pole member and extending axially away from said pole member through said upper armature and said lower armature, wherein said armature guide extends through one of said upper armature and said lower armature in a clearance fit, and wherein said armature guide remains axially stationary when said upper armature and said lower armature move axially to seat and unseat with said upper valve seat and said lower valve seat respectively.

13. A fuel injector as in claim 12 wherein said armature guide comprises:
an armature guide central bore;
an armature guide fuel inlet passage extending radially through said armature guide to provide fluid communication from said fuel injector fuel inlet to said armature guide central bore only when said upper armature is unseated with said upper valve seat; and
an armature guide fuel outlet passage in fluid communication with said armature guide fuel inlet passage and extending radially through said armature guide to provide fluid communication from said armature guide central bore to said fuel injector fuel outlet.

14. A fuel injector as in claim 13 wherein said upper armature includes an upper armature fuel passage groove extending radially in an axial face proximal to said pole member for providing fluid communication from said fuel injector fuel inlet to said armature guide fuel inlet passage when said upper armature is unseated with said upper valve seat.

15. A fuel injector as in claim 12 wherein said upper armature comprises:
an upper armature disk-shaped section disposed axially between said upper valve seat and said pole member; and
an upper armature tubular section extending axially away from said upper armature disk-shaped section toward said lower armature.

16. A fuel injector as in claim 15 wherein said lower armature comprises:
a lower armature disk-shaped section; and
a lower armature tubular section extending axially away from said lower armature disk-shaped section toward said upper armature.

17. A fuel injector as in claim 16 wherein one of said upper armature tubular section and said lower armature tubular section radially surrounds the other of said upper armature tubular section and said lower armature tubular section, and wherein the other of said upper armature tubular section and said lower armature tubular section is a clearance fit with said armature guide.

18. A fuel injector as in claim 17 wherein said lower armature tubular section radially surrounds said upper armature tubular section and said upper armature tubular section is a clearance fit with said armature guide.

19. A fuel injector as in claim 16 wherein said upper armature is of separate construction from said lower armature.

20. A fuel injector as in claim 12 wherein said armature guide includes an adjusting screw with adjusting threads for threadably engaging a lower valve seat adjusting bore of said lower valve seat.

21. A fuel injector as in claim 12 wherein said armature guide comprises:
an armature guide larger diameter section in a clearance fit with said pole member central bore; and
an armature guide smaller diameter section extending axially away from said armature guide larger diameter section and through said upper armature and said lower armature.

22. A fuel injector as in claim 21 further comprising a return spring disposed radially between said armature guide smaller diameter section and pole member and axially between said armature guide larger diameter section and said upper armature for biasing said upper armature away from said pole member.
